(19) United States
(12) Patent Application Publication
(10) Pub. No.: US 2017/0010476 A1
(43) Pub. Date: Jan. 12, 2017

(54) DEVICE FOR ELEVATING EYEGLASSES

(71) Applicant: Elizabeth Becker, Magnolia, NJ (US)

(72) Inventor: Elizabeth Becker, Magnolia, NJ (US)

(21) Appl. No.: 14/794,206

(22) Filed: Jul. 8, 2015

(51) Int. Cl. G02C 5/12

(52) U.S. Cl. CPC G02C 5/124; G02C 2200/10; G02C 2200/20

(57) ABSTRACT

A device for elevating eyeglasses on a nose of a user. The device includes a deformable frame having spaced apart first and second lateral portions for positioning along opposite sides of the nose, each lateral portion having a proximal end and a distal end. A first joint portion extends from the proximal end of the first lateral portion, a second joint portion extends from the proximal end of the second lateral portion, and a central bridge portion extends between the first and second joint portions. A nose pad is attached to the distal end of each of the first and second lateral portions.

### BACKGROUND OF THE INVENTION

The present invention relates in general to accessories for eyeglasses and in particular to a bridge saddle for elevating eyeglasses from their normal seated position on a wearer's nose.

Wearers of bifocal and other special lens eyeglasses must frequently shift their line of sight from the distance portion of the lens to the reading portion and vice versa. Bifocal spectacles are made in such a way that the close vision or reading areas of the lenses are at or near the bottom of the lenses and the distance vision areas of the lenses are near the top thereof. Under normal circumstances when written material is placed on a desk, table or the like, or is simply held substantially below eye level, the bifocals wearer merely casts his or her eyes downward without tilting the head so that he or she may see the print through the close vision portions of the lenses. However, a wearer of bifocal eyeglasses who must read material from a computer screen or other upright surface oftentimes must tilt his or her head back to bring the reading or close vision areas of the lenses into proper position to read the print. Consequently, the bifocals wearer experiences inconvenience and discomfort when having to read material which is at or near eye level, especially when having to do so for extended periods of time.

### BRIEF SUMMARY OF THE INVENTION

According to a first preferred embodiment the present invention provides a device for elevating eyeglasses on a nose of a user. The device includes a deformable frame having spaced apart first and second lateral portions for positioning along opposite sides of the nose. Each lateral portion includes a proximal end and a distal end. The device additionally includes a first joint portion extending from the proximal end of the first lateral portion, a second joint portion extending from the proximal end of the second lateral portion, and a central bridge portion extending between the first and second joint portions. In addition, a nose pad is attached to the distal end of each of the first and second lateral portions.

According to a second preferred embodiment the present invention provides a device for elevating eyeglasses on a nose of a user. The device includes an elongated deformable frame having a first point of inflection between a first end of a curved central bridge portion and a first end of a first joint portion, a second point of inflection between a second end of the first joint portion and a first end of a first lateral portion, a third point of inflection between a second end of the curved central bridge portion and a first end of a second joint portion, and a fourth point of inflection between a second end of the second joint portion and a first end of a second lateral portion. The device further includes a nose pad attached to a second end of each of the first and second lateral portions.

According to a third preferred embodiment the present invention provides an eyewear assembly including a pair of eyeglasses having a bridge assembly for resting about a nose of a user and a nose bridge saddle. The nose bridge saddle includes a deformable frame having spaced apart first and second lateral portions for positioning along opposite sides of the nose. Each lateral portion includes a proximal end and a distal end. The frame further includes a first joint portion extending from the proximal end of the first lateral portion, a second joint portion extending from the proximal end of the second lateral portion, and a central bridge portion extending between the first and second joint portions. Additionally, a nose pad is attached to the distal end of each of the first and second lateral portions for receiving a portion of the bridge assembly.

Owing to the deformable frame, the nose bridge saddle may be selectively manipulated or formed to accommodate the contours of the nose of any wearer. In addition, the nose bridge saddle is entirely disconnected from the eyeglasses it supports and does not have a fixed size or shape which would limit the types of eyeglasses with which it might find beneficial use.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a front view of a device for elevating eyeglasses in accordance with a preferred embodiment of the present invention;

FIG. 1A is a longitudinal cross-sectional view of a frame in accordance with an aspect of the device of FIG. 1;

FIG. 1B is a longitudinal cross-sectional view of a frame in accordance with another aspect of the device of FIG. 1;

FIG. 2A is a front view of the device of FIG. 1 as worn on a user's nose and supporting a pair of eyeglasses;

FIG. 2B is a front view of the eyeglasses of FIG. 2A worn on a user without the device of FIG. 1;

FIG. 3 is a side elevational view of a nose pad applicable to the device of FIG. 1 in accordance with an alternate aspect;

FIG. 3A is a top view of a rigid member applicable to the nose pad of FIG. 3;

FIG. 3B is a top view of another rigid member applicable to the nose pad of FIG. 3;

FIG. 3C is a top view of yet another rigid member applicable to the nose pad of FIG. 3;

FIG. 3D is a top view of another rigid member applicable to the nose pad of FIG. 3; and

FIG. 4 is a front view of a package applicable to a kit in accordance with another aspect of the present invention.

### DETAILED DESCRIPTION OF THE INVENTION

Reference will now be made in detail to a preferred embodiment of the invention illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. Such directional terms used in conjunction with the following description of the drawings should not be construed to limit the scope of the invention in any manner not explicitly set forth.

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the identified element and designated parts thereof. Additionally, the term “a,” as used in the specification, means “at least one.” The terminology includes the words noted above, derivatives thereof and words of similar import.

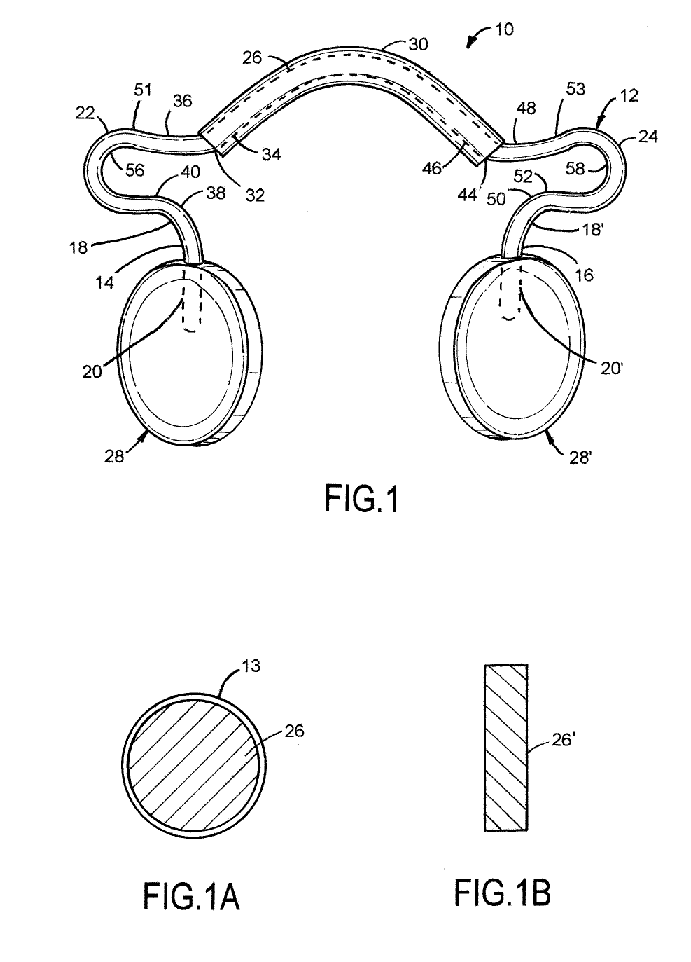

Referring to FIG. 1, there is shown a device 10 in accordance with a preferred embodiment of the present invention for elevating eyeglasses on a nose of a user which will be referred to herein as an eyeglasses nose bridge saddle or, simply, “nose bridge saddle.” The nose bridge saddle 10 includes a deformable frame 12 and a nose pad 28.

The deformable frame includes spaced apart first and second lateral portions 14, 16 for positioning along opposite sides of the nose, first and second joint portions 22, 24 and a central bridge portion 26. Each lateral portion has a proximal end 18, 18′ and a distal end 20, 20′. The distal ends 20, 20′ being the ends closest to the point of attachment of the nose pads 28, 28′, respectively.

The deformable frame 12 can optionally be covered or coated with a coating 13 (FIG. 1A), such as a polymer, for further stability and comfort purposes. Exemplary materials applicable for the coating include an elastomer, a rubber, a pliable plastic, silicone, and the like.

The first joint portion 22 extends from the proximal end 18 of the first lateral portion 14, the second joint portion 24 extends from the proximal end 18′ of the second lateral portion 16, and the central bridge portion 26 extends between the first and second joint portions. Each the first and second joint portions 22, 24 are preferably substantially C-shaped curved portions having a curve of about 190 to 350 degrees and, preferably about 200 to 320 degrees, and more preferably about 200 to 250 degrees. However, the curve of the C-shaped curved portion can alternatively be configured having an arc distance of 210, 220, 230, 240, 260, 270, 280, 290, 300, 310, 330, and 340 degrees. Further, each of the first and second joint portions can alternatively be configured to have a non-linear shape such as a V-shape, trapezoidal shape, W-shape, and the like.

The central bridge portion 26 is a curved portion connecting each lateral portion. Preferably, the curved portion spans a width about 2 to 4 times the overall width of an individual joint portion, and preferably a width of about 3 times the overall width of an individual joint portion.

The central bridge portion 26 can optionally include a sleeve 30, such as a pliable sleeve. The sleeve 30 circumscribes the central bridge portion 26 and serves as padding in order to prevent the central bridge portion from pressing into the skin of the bridge of the user's nose and causing discomfort. Moreover, the sleeve functions to stabilize the bridge portion when a user desires to deform the nose bridge saddle. The sleeve also serves to increase the force necessary to deform the central bridge portion relative to each of the lateral portions 22, 24. Thus, when a user deforms the nose bridge saddle about his/her nose, the sleeve facilitates even bending/deformation while simultaneously allowing the lateral joint portions to deform to a greater extent as a user will apply pressure to the lateral joint portions directly to deform the nose bridge saddle.

Preferably, the sleeve 30 intimately engages the central bridge portion so as to minimize play or movement between the sleeve and the central bridge portion. The sleeve is also preferably configured to have a length sufficient to span the entire width of the central bridge portion. The sleeve 30 can be formed from a polymer, such as an elastomer, a rubber, a pliable plastic, silicone, and the like.

The deformable frame or elongated deformable frame 12 comprises a deformable elongated cylindrical member, such as a metal wire or the like. The metal wire can be copper, gold, platinum, silver and the like. Preferably, the deformable frame is formed from a metal wire having a gauge thickness of 18, 20, 22, 24, 26, 28 or 30.

Similar to the rest of the frame 12, the central bridge portion 26 is formed from a deformable elongated cylindrical member e.g., a metal wire. FIG. 1A shows in cross-section the deformable elongated cylindrical member of the central bridge portion. However, the central bridge portion 26 is preferably formed out of a flat or flattened elongated member elongated 26′, as shown in cross-section in FIG. 1B. The flattened configuration of the central bridge portion 26′ stabilizes the central bridge portion when the nose bridge saddle 10 is deformed against a user's nose. That is, the flattened configuration of the central bridge portion facilitates even or symmetrical deformation of the nose bridge saddle about the user's nose.

The nose bridge saddle advantageously allows a user to easily deform it about his/her nose. This deformability is attributed to the deformable nature of the deformable frame 12 in combination with the shape of the central bridge portion, lateral portions and joint portions. Specifically, the joint portions are more easily deformable to conform to the user's nose owing to its curved bulbous-like shape than either of the central bridge portion or joint portions. Moreover, the curved joint portions allow flexibility of the respective lateral portions relative to the central bridge portion about the joint portions. Thus, each of the lateral portions are moveable or deformable about both the central bridge portion and their respective joint portions.

So constructed and arranged, the deformable frame 12 is thus defined by a plurality of inflection points which impart its unique shape and functionality. More specifically, the elongated deformable frame 12 includes a first point of inflection 32, a second point of inflection 38, a third point of inflection 44 and a fourth point of inflection 50. The first point of inflection 32 lies between a first end 34 of the curved central bridge portion 26 and a first end 36 of the first joint portion 22. The second point of inflection 38 is located between a second end 40 of the first joint portion 22 and a first end or proximal end 18 of the first lateral portion 14. The third point of inflection 44 is situated between a second end 46 of the curved central bridge portion 26 and a first end 48 of the second joint portion 24. The fourth point of inflection 50 is disposed between a second end 52 of the second joint portion 24 and a first end or proximal end 18′ of the second lateral portion 16.

The elongated deformable frame further includes a fifth point of inflection 51 and a sixth point of inflection 53. The fifth point of inflection 51 is between the first and second points of inflections 32, 38. The sixth point of infection 53 is between the third and fourth points of inflections 44, 50. The fifth and sixth points of infection 51, 53 are also within the first and second joint portions 22, 24, respectively.

Nose pads 28, 28′ are fixedly attached to the distal end 20, 20′ of each of the first and second lateral portions, respectively. The nose pad is configured as shown in FIG. 1 and preferably shaped as a circular nose pad. However, the nose pad can alternatively be any other shape suitable for its intended purpose, such as oval, square, rectangle, octagon and the like. Further, the overall width or diameter of the nose pads 28, 28′ desirably ranges from about ¼ to ½ inch to provide sufficient surface area on which eyeglasses nose pads can rest on.

The nose pads being connected to the respective distal ends of the lateral portions advantageously allows the nose pads to be adjustable relative to the central bridge portion, and the respective joint portions. Each nose pad is also rotationally adjustable relative to the central bridge portion, and the respective joint portions as a result of the deformable and linear nature of the respective lateral portions.

The nose pads are preferably formed of silicone or an elastomer so as to have sufficient stiction or static friction when applied to the nose surface to fixedly support eyeglasses thereon. That is, each nose pad has sufficient stiction to remain in position when worn by a user for elevating eyeglasses worn by the user. While silicone or elastomers are the preferred materials for forming the nose pad, other suitable materials having sufficient stiction to support eyeglasses when used in conjunction with the present embodiment can be used.

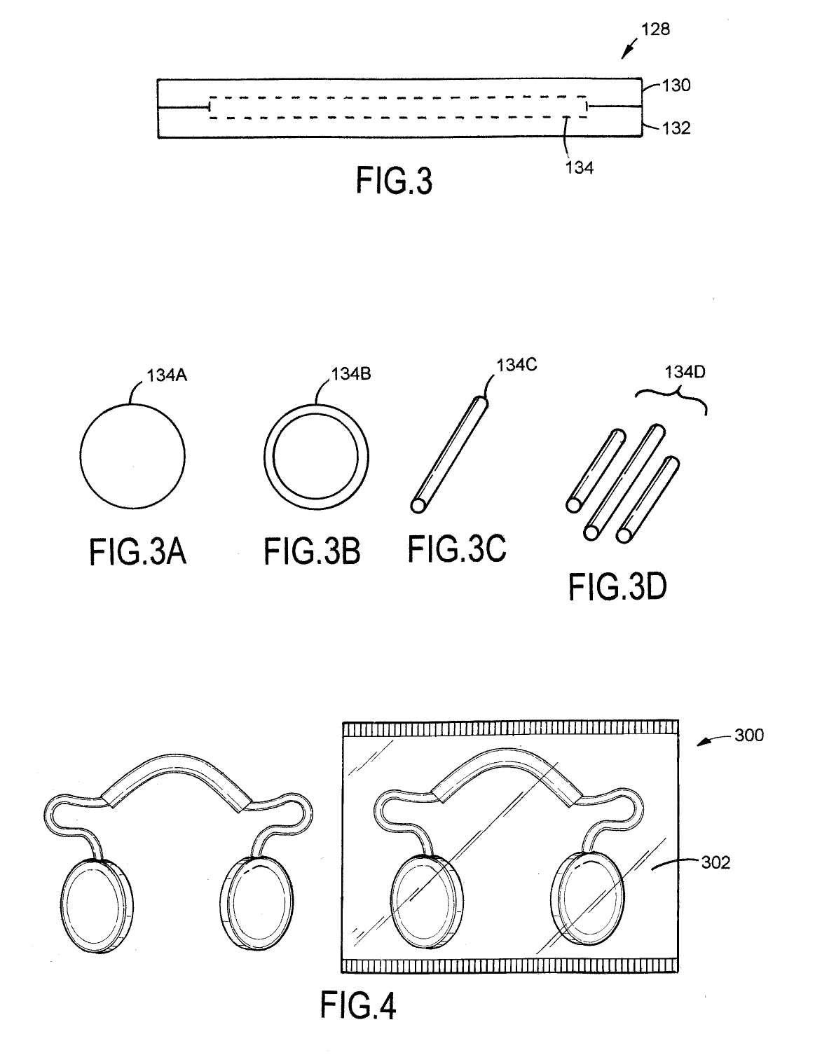

In accordance with an aspect of the present embodiment, the nose pad can be configured as a layered structure nose pad 128 (FIG. 3) having a pliable member and a rigid member. The nose pad 128 includes a top layer 130 and a bottom layer 132 each formed of the same material or differing materials. The pliable member can be either the top or bottom layer or collectively both the top and bottom layers combined. Sandwiched between the top and bottom layers is a reinforcement member 134 that defines the rigid member. That is, the right member is surrounded by the pliable member. The reinforcement member 134 can be configured as a circular member 134A, a washer 134B, a rod 134C, a plurality of rods 134D, or the like.

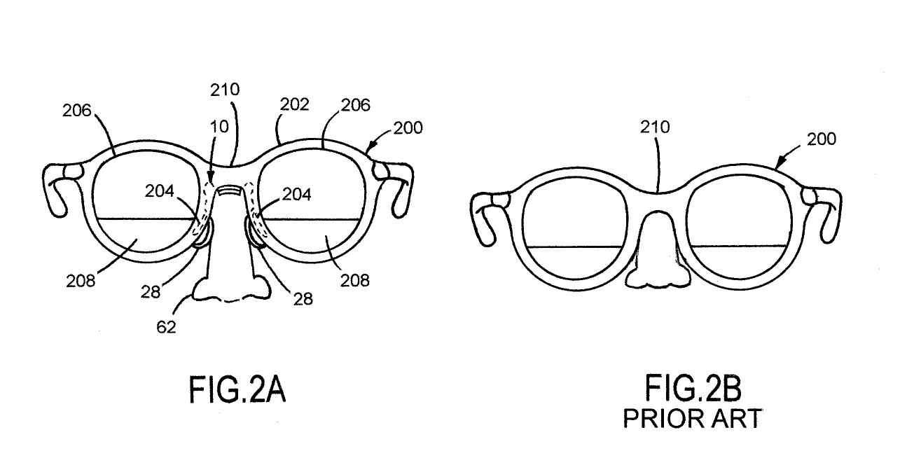

The foregoing nose bridge saddle 10 in combination with a pair of eyeglasses 200 (FIG. 2A) comprise an eyewear assembly. The pair of eyeglasses 200 has a frame 202 which includes a bridge assembly 210 which carries a pair of spaced apart nose pads 204 that normally rest on either side of the user's nose when the eyeglasses are worn, and a pair of lenses 206. The nose bridge saddle is configured as described above having a deformable frame that includes spaced apart first and second lateral portions for positioning along opposite sides of the nose wherein each lateral portion has a proximal end and a distal end, a first joint portion extending from the proximal end of the first lateral portion, a second joint portion extending from the proximal end of the second lateral portion, and a central bridge portion extending between the first and second joint portions. The nose bridge saddle also includes a nose pad attached to the distal end of each of the first and second lateral portions for receiving a portion of the bridge assembly 210.

FIG. 2A illustrates the nose bridge saddle 10 worn by a user and supporting a pair of eyeglasses 200. When the nose bridge saddle is used in combination with bifocals having a lower lens area 208, the nose bridge saddle raise the eyeglasses and consequently the lower lens area compared to when the glasses are worn without the nose bridge saddle, as shown in comparison to FIG. 2B.

In operation, the user bends/deforms the nose bridge saddle 10 into a desired shape that fits the contours of his or her nose by placing the nose bridge saddle against the nose and applying pressure about the joint portions. Pressure is applied to the nose bridge saddle until the nose pads 28, 28′ sufficiently rest against the nose surface. Thereafter, the user dons and places the nose pads 204 or a portion of the bridge assembly of the eyeglasses in abutting contact with the nose pads of the nose bridge saddle. In this manner, the eyeglasses 200 simply rest on the nose bridge saddle and remain in position due to the static friction between the eyeglasses nose pads 204 (or bridge assembly) and the nose pads 28, 28′ of the nose bridge saddle.

The nose bridge saddle is completely disconnected from the eyeglasses it supports thereby rendering it easy to use. For example, the user does not have to attach the nose bridge saddle to the eyeglasses in order to use the bridge saddle and thereafter detach the nose bridge saddle when the user no longer requires it. Moreover, the nose bridge saddle does not have a fixed size or shape which would limit the types and sizes of eyeglasses with which it can be used with.

In accordance with another aspect of the present embodiment as shown in FIG. 4, the present invention provides a kit that includes the nose bridge saddle as described above and a package 300. The package 300 is configured to package the nose bridge saddle, and can be e.g., a form/fill/seal type package. The package is formed from packaging material 302 having a mirror-like surface or a high reflectivity surface e.g., metallised polyester or foil. Thus, when a user removes the nose bridge saddle from the package 300, the user can then use the package as a mirror to help facilitate placement of the nose bridge saddle on his or her nose.

It will be appreciated by those skilled in the art that changes could be made to the embodiments described above without departing from the broad inventive concept thereof. It is to be understood, therefore, that this invention is not limited to the particular preferred embodiments disclosed, but it is intended to cover modifications within the spirit and scope of the present invention as defined by the appended claims.

What is claimed is:

1. A device for elevating eyeglasses on a nose of a user comprising:
a deformable frame that includes:
spaced apart first and second lateral portions for positioning along opposite sides of the nose, each lateral portion having a proximal end and a distal end,
a first joint portion extending from the proximal end of the first lateral portion,
a second joint portion extending from the proximal end of the second lateral portion, and
a central bridge portion extending between the first and second joint portions; and
a nose pad attached to the distal end of each of the first and second lateral portions.

2. The device of claim 1, wherein each of the first and second joint portions are substantially C-shaped.

3. The device of claim 1, wherein each of the first and second joint portions are curved portions.

4. The device of claim 3, wherein each of the first and second joint portions have a curve of about 190 to 350 degrees.

5. The device of claim 1, wherein the deformable frame includes a deformable elongated cylindrical member.

6. The device of claim 5, wherein the deformable elongated cylindrical member is a metal wire.

7. The device of claim 1, further comprising a sleeve circumscribing the central bridge portion.

8. The device of claim 1, wherein each nose pad has sufficient stiction to remain in position when worn by a user for elevating eyeglasses worn by the user.

9. The device of claim 1, wherein each nose pad has a static friction sufficient to fixedly support eyeglasses on when applied to the nose.

10. The device of claim 1, wherein each nose pad comprises at least one of silicone and an elastomer.

11. The device of claim 1, wherein each nose pad comprises a rigid member and a pliable member.

12. The device of claim 11, wherein the pliable member comprises at least one of silicone and an elastomer.

13. The device of claim 11, wherein in the rigid member is surrounded by the pliable member.

14. A kit comprising:
the device of claim 1; and
a package for packaging the device, wherein the package includes packaging material having a mirror-like surface.

15. A device for elevating eyeglasses on a nose of a user comprising:
an elongated deformable frame that includes:
a first point of inflection between a first end of a curved central bridge portion and a first end of a first joint portion,
a second point of inflection between a second end of the first joint portion and a first end of a first lateral portion,
a third point of inflection between a second end of the curved central bridge portion and a first end of a second joint portion, and
a fourth point of inflection between a second end of the second joint portion and a first end of a second lateral portion; and
a nose pad attached to a second end of each of the first and second lateral portions.

16. The device of claim 15, further comprising:
a fifth point of inflection between the first and second points of inflection; and
a sixth point of inflection between the third and fourth points of inflection.

17. The device of claim 15, wherein each of the first and second joint portions has a curve of about 200 to 250 degrees.

18. An eyewear assembly comprising:
a pair of eyeglasses having a bridge assembly for resting about a nose of a user; and
a nose bridge saddle that includes:
a deformable frame having:
spaced apart first and second lateral portions for positioning along opposite sides of the nose, each lateral portion having a proximal end and a distal end,
a first joint portion extending from the proximal end of the first lateral portion,
a second joint portion extending from the proximal end of the second lateral portion, and
a central bridge portion extending between the first and second joint portions, and
a nose pad attached to the distal end of each of the first and second lateral portions for receiving a portion of the bridge assembly.

19. The eyewear assembly of claim 18, wherein the central bridge portion curves inwardly and downwardly.

20. The eyewear assembly of claim 18, wherein the central bridge portion comprises a flattened elongated member.
